(19) United States
(12) Patent Application Publication
(10) Pub. No.: US 2009/0241309 A1
(43) Pub. Date: Oct. 1, 2009

(54) Environmentally safe fantasy coffin/caskets

(76) Inventor: Venus Valeta Smith, Jersey City, NJ (US)

Correspondence Address: Venus Smith, 402 Bergen Avenue, Jersey City, NJ, 07304, US

(21) Appl. No.: 12/383,992

(22) Filed: Mar. 30, 2009

Related U.S. Application Data
(60) Provisional application No. 61/072,370, filed on Mar. 31, 2008.

(51) Int. Cl. A61G 17/007; A61G 17/00

(52) U.S. Cl. 27/2

(57) ABSTRACT

This invention is that a specific object is manually or by machine hot wire cut, die cut, hand carved and/or sculpted out of a block of earth friendly material preferably but not limited to (GCE) Biodegradable Water Resistant Green Cell foam for creating a burial casket. The casket is then painted with Green Seal Certified paints. The casket is then cut or carved into a top and bottom piece. A tongue and groove is carved into the top and bottom pieces for a secured closure. An organic unbleached calico cotton mattress filled with organic wool is inside the casket for the cadaver. Before burial the casket is sealed with organic biodegradable glue.

Depending on size some desired objects may start out with more than two parts. In that event the objects would be glued together and then cut into a top and bottom piece.

This invention is customized burial caskets made from earth friendly materials in an extreme artistic appearance. These caskets are for pets, infants, children and adult human beings during their time of burial.

Each casket is cut, carved and/or sculpted into a specific object out of a earth friendly material. The casket is then cut into two pieces, a top (1C) and a bottom (1B). A tongue (1D) and groove (1E) is cut, carved and/or sculpted into the top and bottom for a fitted closure. Handles are cut, carved and/or sculpted into the sides of the casket eliminating unnecessary hardware. The casket is painted with Green Seal Certified paints. Each casket contains a calico mattress for the cadaver. The caskets top (1C) and bottom (1B) will be sealed with organic based glue prior to burial.

The casing (1A) may be formed of any suitable earth friendly and/or biodegradable material having the desired structural strength for burial or for shipment as described hereinafter. For example, the casing (1A) may be formed of suitable structurally strong foam such as the water resistant, biodegradable corn starch based green cell foam (GCE), organic based materials, clay or cork. Preferably the caskets are formed of the biodegradable corn starch based green cell foam (GCE) for shipment and for use in dry soils.

### CROSS-REFERENCE TO RELATED APPLICATIONS

US Patents

| | | | |
|---|---|---|---|
| 1,989,962 | November 1930 | Zinser/Scott | 27---3 |
| 3,188,712 | July 1962 | Bauermeister | 27---6 |
| 3,838,482 | November 1973 | Wallace | 27/22.100 |

Foreign Patents

| | | |
|---|---|---|
| 072,132 | July 2006 | Allison Melbourne, Australia |

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Due to the expanding population in the US the amount of wood, steel, copper, bronze and concrete that we are putting into the earth for burials is catastrophic and harmful to our environmental future. Caskets have traditionally been made out of wood or gauge steel with minimal artistic appearance. It is therefore, the object of this invention to provide environmentally friendly and biodegradable burial caskets constructed with cork, polymers or starch based products and/or a biodegradable foam.

A further object of this invention is to construct each casket to a desired specific object. Providing a casket that replicates the object desired in precise detail while incorporating Green Seal Certified paints for the finishing touches continues the idea of a completely earth friendly product.

A further object of this invention is to carve a tongue and groove into the casket for a secured closing. This type of closing prevents the necessity of any hardware such as brackets, hinges, etc. These caskets are constructed in two parts, a top and a bottom.

### BRIEF SUMMARY OF THE INVENTION

This invention is customized burial caskets made with environmentally safe materials for encasing pets, infants, children and adult human beings. This invention helps to improve the existing environmental crisis in the world today by changing the materials used for caskets. Annually over 6 million burials occur worldwide leaving us with a need of a new form of burial casing that doesn't destroy the earth.

### BRIEF DESCRIPTION OF THE SEVERAL VIEWS OF THE DRAWING

FIG. 1A is an example of a casket carved into Volkswagen car

FIG. 1B is an example of the bottom piece of the Volkswagen car casket that holds the cadaver

FIG. 1C is an example of the top piece of the Volkswagen car casket

FIG. 1D is an example of the top piece of the casket with the tongue

FIG. 1E is an example of the bottom piece of the casket with the groove

### DETAILED DESCRIPTION OF THE INVENTION

This invention is customized burial caskets made from earth friendly materials in an extreme artistic appearance. These caskets are for pets, infants, children and adult human beings during their time of burial.

Each casket is cut, carved and/or sculpted into a specific object out of an earth friendly material. The casket is then cut into two pieces, a top and a bottom. A tongue and groove is cut, carved and/or sculpted into the top and bottom for a fitted closure. Handles are cut, carved and/or sculpted into the sides of the casket eliminating unnecessary hardware. The casket is painted with Green Seal Certified paints. Each casket contains a calico mattress for the cadaver. The caskets top and bottom will be sealed with organic based glue prior to burial.

The casing (1) may be formed of any suitable earth friendly and/or biodegradable material having the desired structural strength for burial or for shipment as described hereinafter. For example, the casing (1) may be formed of suitable structurally strong foam such as the water resistant, biodegradable corn starch based green cell foam (GCE), organic based materials, clay or cork. Preferably the caskets are formed of the biodegradable corn starch based green cell foam (GCE) for shipment and for use in dry soils.

### DRAWINGS

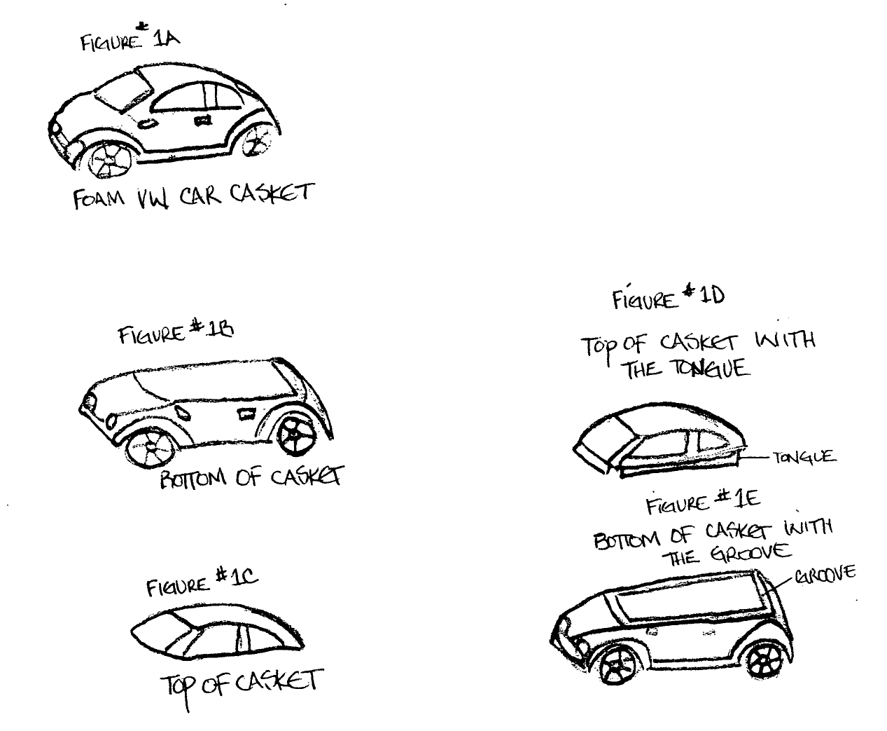

FIG. 1A is an example of a casket carved into Volkswagen car

FIG. 1B is an example of the bottom piece of the Volkswagen car casket that holds the corpse

FIG. 1C is an example of the top piece of the Volkswagen car casket

FIG. 1D is an example of the top piece of the casket with the tongue

FIG. 1E is an example of the bottom piece of the casket with the groove

### SEQUENCE LISTING

“Not Applicable”

1) Extremely Artistic Earth Friendly Caskets
(a) A specified object is cut, carved and/or sculpted out of an earth friendly material formed into a burial casing for pets, infants, children and adult human cadavers. Object examples are a car, plane, high heeled shoe, dog, cat, etc.
(b) Various materials fit the criteria for earth friendly such as (GCE) water resistant, green cell foam which is biobased and biodegradable. Clay, cork and an organic based, earth friendly (EPS) expanded polystyrene can also be used.
(c) The burial casing is finished with earth conscious paints; Green Seal Certified
(d) The caskets are sealed with an organic biobased and biodegradable glue.
(e) Inside the casket is a mattress made of calico; an organic unbleached cotton.
